(19) United States
(12) Patent Application Publication
(10) Pub. No.: US 2016/0249344 A1
(43) Pub. Date: Aug. 25, 2016

(54) Method and Apparatus for Providing a Degree of a Resource Pool Occupation of Resources Used in Device-to-Device Communication

(71) Applicant: Rohde & Schwarz GmbH & Co. KG, Munchen (DE)

(72) Inventors: Juergen SCHLIENZ, Poing (DE); Sandra MERKEL, Munchen (DE)

(21) Appl. No.: 14/629,402

(22) Filed: Feb. 23, 2015

(51) Int. Cl. H04W 72/04; H04W 24/08; H04W 76/04

(52) U.S. Cl. CPC H04W 72/0413; H04W 76/043; H04W 72/042; H04W 24/08

(57) ABSTRACT

A method for providing a degree of occupation of at least one resource pool of resources used in device-to-device, D2D, communication between user equipment, UE, devices of a network, said method comprising the steps of measuring at least one resource parameter of a resource by a user equipment, UE, device; deciding by said user equipment, UE, device whether the respective resource of said resource pool is occupied depending on the measured resource parameter and at least one configurable decision criterion; informing a base station, BS, of said network about the occupation of resources of said resource pool by the user equipment, UE, device when the user equipment, UE, device is in coverage of said base station, BS; and evaluating the information about occupation of resources of said at least one resource pool received from user equipment, UE, devices to derive the degree of resource pool occupation.

### TECHNICAL BACKGROUND

The invention relates to a method and apparatus for providing a degree of occupation of at least one resource pool of resources used in device-to-device, D2D, communication between user equipment, UE, devices of a network.

Communication networks such as Long Term Evolution, LTE, employ base stations such as Node B or Evolved Node B base-stations. User equipment, UE, devices can communicate with other user equipment, UE, devices via at least one base station. Alternatively, it is possible that user equipment devices can communicate with each other directly using resources defined by the network via a direct device-to-device, D2D, communication. For a device-to-device communication resource pools are provided. Different resource pools are provided for in coverage and partial coverage communication and direct communication. In most cases, base stations cannot control to what extent device-to-device, D2D, resources are currently used. As a result, it may happen that the resources of the resource pool are not sufficient or that too many resources are provided unnecessarily.

Accordingly, there is a need to provide a method and apparatus for providing a degree of occupation of resources used in device-to-device, D2D, communication between user equipment devices of a network.

### SUMMARY OF THE INVENTION

The invention provides according to a first aspect of the present invention a method for providing a degree of occupation of at least one resource pool of resources used in device-to-device, D2D, communication between user equipment, UE, devices of a network, the method comprising the steps of: measuring at least one resource parameter of a resource by a user equipment, UE, device, deciding by said user equipment, UE, device whether the respective resource of said resource pool is occupied depending on the measured resource parameter and at least one configurable decision criterion, informing a base station, BS, of said network about the occupation of resources of said resource pool by the user equipment, UE, device when the user equipment, UE, device is in coverage of said base station, BS, and evaluating the information about occupation of resources of said at least one resource pool received from user equipment, UE, devices to derive the degree of resource pool occupation.

In a possible embodiment of the method according to the first aspect of the present invention, a resource allocation of resources within a network cell of said base station, BS, is changed in response to the derived degree of resource pool occupation.

In a further possible embodiment of the method according to the first aspect of the present invention, the decision criterion comprises a configurable parameter threshold.

In a possible embodiment of the method according to the first aspect of the present invention, the decision criterion comprises a configurable parameter threshold and the measured resource parameter is compared with the configurable parameter threshold by the user equipment, UE, device to decide whether the respective resource of said resource pool is occupied due to device-to-device, D2D, signaling.

In a still further possible embodiment of the method according to the first aspect of the present invention, the measured resource parameter comprises a signal strength and/or a signal power of signals and/or messages received by said user equipment, UE, device from other user equipment, UE, devices via resources of said resource pool.

In a further possible embodiment of the method according to the first aspect of the present invention, the decision criterion comprises a decision whether a resource of said resource pool is used in device-to-device, D2D, signaling.

In a further possible embodiment of the method according to the first aspect of the present invention, the user equipment, UE, device transmits to the base station, BS, of said network a report message, RM, indicating a measured occupancy of resources of said resource pool.

In a further possible embodiment of the method according to the first aspect of the present invention, the measured occupancy is transmitted by the user equipment, UE, device to the base station, BS, on a resource level, a resource group level, a resource block level or as a degree of occupancy of a resource pool.

In a further possible embodiment of the method according to the first aspect of the present invention, the report message, RM, transmitted by said user equipment, UE, device is triggered by an occupation state of a resource of said resource pool.

In a further possible alternative embodiment of the method according to the first aspect of the present invention, the report message, RM, transmitted by the user equipment, UE, device is transmitted by the user equipment, UE, device in response to a request received from said base station, BS.

In a still further possible alternative embodiment of the method according to the first aspect of the present invention, the report message, RM, transmitted by said user equipment, UE, device is transmitted by said user equipment, UE, device periodically.

In a further possible embodiment of the method according to the first aspect of the present invention, the report message, RM, transmitted by said user equipment, UE, device to said base station, BS, comprises position data indicating a position of said user equipment, UE, device when performing the measurement of the at least one resource parameter of a resource of said resource pool.

In a further possible embodiment of the method according to the first aspect of the present invention, the measuring of at least one resource parameter of said resource pool by said user equipment, UE, device is initiated by said user equipment, UE, device in response to a measurement command message, MCM, transmitted by said base station, BS, to said user equipment, UE, device.

In a possible embodiment of the method according to the first aspect of the present invention, the measurement command message, MCM, transmitted by said base station, BS, specifies the at least one resource parameter to be measured by said user equipment, UE, device.

In a further possible embodiment of the method according to the first aspect of the present invention, the measurement command message, MCM, transmitted by said base station, BS, specifies a measurement time period to be used by said user equipment, UE, device.

In a still further possible embodiment of the method according to the first aspect of the present invention, the measurement command message, MCM, transmitted by said base station, BS, specifies an area for measurement of the resource parameter of the resource of said resource pool.

In a still further possible embodiment of the method according to the first aspect of the present invention, the measurement command message, MCM, transmitted by said base station, BS, specifies a set or subset of resources of at least one resource pool to be monitored by said user equipment, UE, device.

In a still further possible embodiment of the method according to the first aspect of the present invention, the measurement command message, MCM, transmitted by said base station, BS, specifies at least one condition when a report message, RM, is to be transmitted by said user equipment, UE, device to said base station, BS.

In a still further possible embodiment of the method according to the first aspect of the present invention, the information about occupation of resources of said resource pool carried in report messages, RM, of different user equipment, UE, devices to said base station, BS, is evaluated by the base station, BS.

In a further possible embodiment of the method according to the first aspect of the present invention, the information about occupation of resources of said resource pool carried in report messages, RM, of different user equipment, UE, devices to said base station, BS, is evaluated by a control unit of said network to derive a degree of resource pool occupation in at least one network cell of said network.

The invention further provides according to a second aspect a user equipment, UE, device of a network, said user equipment, UE, device comprising: a measurement unit adapted to measure at least one resource parameter of a resource of a resource pool used in a device-to-device, D2D, communication between user equipment, UE, devices of said network, a processing unit adapted to decide whether a resource of said resource pool is occupied depending on the measured resource parameter and depending on at least one configurable decision criterion, and a transceiver unit for communication of said user equipment, UE, device with a base station, BS, of said network and other user equipment, UE, devices, wherein a report message, RM, is transmitted by said transceiver unit of said user equipment, UE, device to said base station, BS, indicating a measured occupancy of resources of said resource pool.

The invention further provides according to a third aspect a base station, BS, of a network comprising a transceiver unit for communication with user equipment, UE, devices according to the second aspect of the present invention, being in coverage of said base station, BS, wherein said transceiver unit is adapted to transmit measurement command messages, MCM, to user equipment, UE, devices and to receive report messages, RM, from user equipment, UE, devices.

In a possible embodiment of the base station according to the third aspect of the present invention, the base station comprises an evaluation unit adapted to evaluate information about occupation of a set or subset of resources carried in report messages, RM, received from user equipment, UE, devices to derive a degree of resource pool occupation.

In a still further possible embodiment of the base station according to the third aspect of the present invention, the base station, BS, is adapted to change a resource allocation of resources used within a network cell of said base station, BS, in response to the degree of resource pool occupation.

The invention further provides according to a fourth aspect a network comprising at least one base station, BS, according to the third aspect of the present invention being adapted to communicate with user equipment, UE, devices according to the second aspect of the present invention being in coverage of said base station, BS.

In a possible embodiment of the network according to the fourth aspect of the present invention, the network is a Long Term Evolution, LTE, network comprising at least one eNodeB as a base station, BS, adapted to communicate with mobile user equipment, UE, devices in coverage of said eNodeB.

### BRIEF DESCRIPTION OF FIGURES

FIG. 1 shows schematically a network cell of a communication network employing the method and apparatus according to the present invention;

FIG. 2 shows a block diagram of an exemplary embodiment of a user equipment, UE, device in the network cell as illustrated in FIG. 1;

FIG. 3 shows a block diagram of an exemplary embodiment of a base station, BS, within the network cell as illustrated in FIG. 1;

FIG. 4 shows a flowchart of an exemplary embodiment of a method according to an aspect of the present invention;

FIG. 5 is a signal diagram illustrating the transmission of report messages by a user equipment device to a base station according to a possible exemplary embodiment of the method illustrated in FIG. 4;

FIG. 6 shows a further signal diagram illustrating the transmission of measurement command messages and report messages in a possible exemplary embodiment of the method as illustrated in FIG. 4;

FIG. 7 shows schematically the resource structure with normal cyclic prefix in a possible exemplary communication network using the method and apparatus according to the present invention.

### DETAILED DESCRIPTION OF EMBODIMENTS

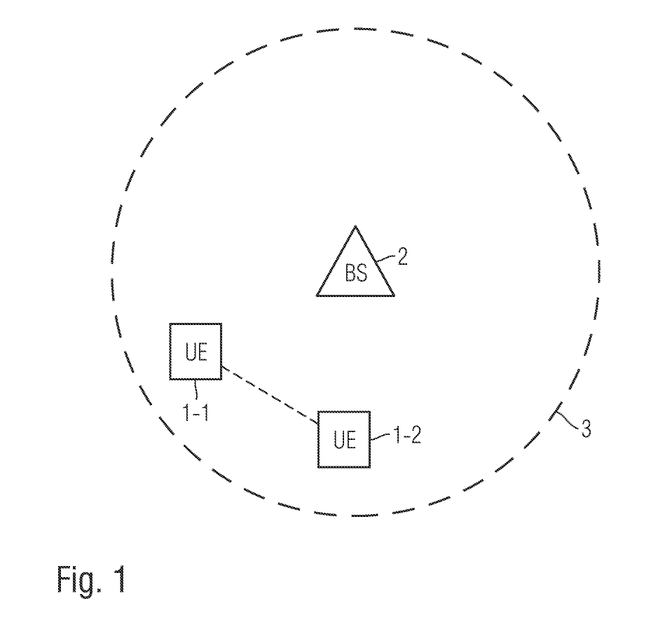

FIG. 1 shows schematically user equipment devices 1-1, 1-2 communicating with each other via a wireless link. The user equipment devices 1-1, 1-2 can communicate with each other directly in a specific operation mode without use of a base station 2 of a network cell 3 of a cellular communication network. In the schematic diagram illustrated in FIG. 1, both user equipment devices 1-1, 1-2 are in coverage of the base station 2 of the network cell 3. It is also possible that only one user equipment, UE, device of the user equipment device pair illustrated in FIG. 1 is in coverage of the base station 2 and that the other user equipment device is out of coverage of the base station 2. In a possible embodiment, the communication network is a cellular Long Term Evolution, LTE, network using orthogonal frequency division multiplexing, OFDM, for the downlink, i.e. from the base station 2 to a user equipment, UE, device. The orthogonal frequency division multiplexing, OFDM, is a frequency division multiplexing, FDM, scheme used as a digital multicarrier modulation process. The OFDM meets the LTE requirement for spectrum flexibility and enables solutions for wide carriers with high peak rates.

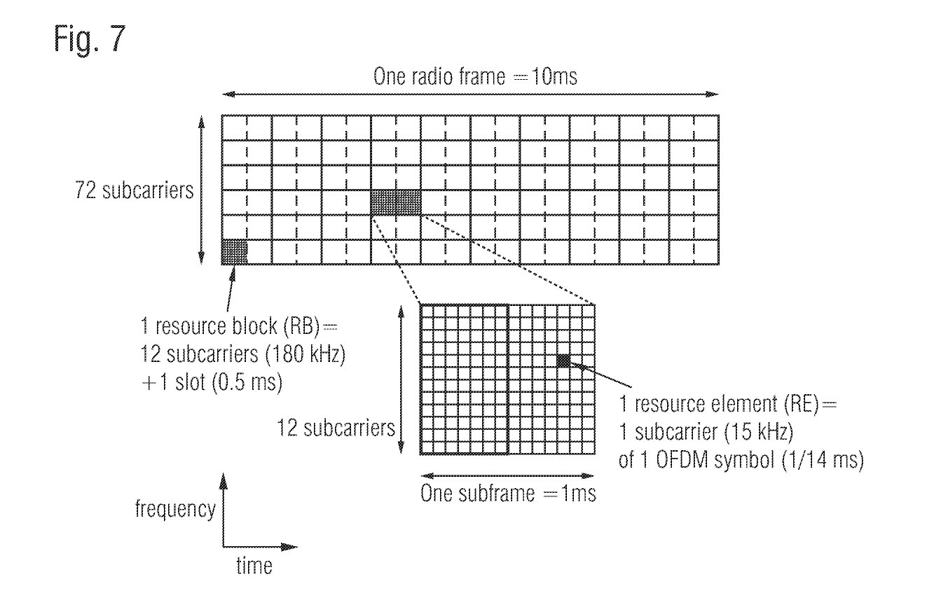

The basic LTE downlink physical resource can be seen as a time frequency grid as illustrated in FIG. 7. As can be seen in FIG. 7, a radio frame of 10 milliseconds can comprise ten subframes each having a length of 1 millisecond. Each subframe can comprise two timeslots having 0.5 milliseconds. In the illustrated embodiment, 72 narrow subcarriers are used for multicarrier transmission to carry data. In the embodiment illustrated in FIG. 7, a resource block does encompass twelve subcarriers and a timeslot. A resource element, RE, within a resource block can comprise one subcarrier in the range of 15 kHz of one OFDM symbol ( 1/14 milliseconds). Each user equipment, UE, device is allocated a number of resource blocks, RB, in the time frequency grid. The more resource blocks a user equipment device gets allocated and the higher the modulation used in the resource elements, the higher the transmission bit rate becomes. Which resource blocks and how many resource blocks the user equipment, UE, device gets allocated at a given point in time depends in a preferred embodiment on an advanced scheduling mechanism in the frequency and time dimensions.

The communication network can provide sidelink transmissions for proximity-based, ProSe, services including direct device-to-device communication between user equipment, UE, devices. The sidelink transmissions can use the same frame structure as the frame structure that is defined for the uplink, UL, and the downlink, DL, when the user equipment devices are in network coverage. In a possible embodiment, the sidelink transmissions can be restricted to a subset of uplink resources in the time and frequency domain. A sidelink can use uplink resources in a physical channel structure similar to uplink transmissions.

A direct communication node is a node of communication whereby user equipment, UE, devices can communicate with each other directly over an interface. In a possible embodiment, this communication node is supported when the user equipment, UE, device is served by an Evolved Universal Terrestrial Radio Access Network, EUTRAN, and when the user equipment, UE, device is outside of coverage. The user equipment, UE, device can perform direct communication on subframes which can be divided over the duration of a sidelink control period. The sidelink control period is the period over which resources allocated in a network cell for sidelink control and sidelink data transmissions occur. A user equipment device supporting direct communication can operate in a possible embodiment in different modes for resource allocation. In a possible embodiment, the user equipment, UE, device can request transmission resources from the base station 2 of the network cell 3 and the base station 3 schedules transmission resources for transmission of sidelink control and data. The user equipment, UE, device on its own can select resources from resource pools to transmit sidelink control and data. The user equipment, UE, device is in coverage for direct communication whenever the user equipment, UE, device detects a network cell on a proximity service carrier. If the user equipment, UE, device is out of coverage it can only use user equipment autonomous resource selection. If the user equipment, UE, device is in coverage it may use scheduled resource allocation or autonomous resource selection.

For resource allocation, the base station 2 can broadcast periodically a system information block, SIB, message via a physical broadcast channel. A specific system information block, SIB, type can contain information related to proximity service, ProSe, direct communication and another specific system information block, SIB, type can contain information related to proximity service direct discovery. Resources used for direct communication can comprise common device-to-device, D2D, transmission resources and dedicated device-to-device, D2D, transmission resources. Further, the resources can comprise cellular resources, for instance a resource pool assignment can assign 70% of the resources to cellular resources, 20% to common device-to-device, D2D, transmission resources and 10% to dedicated device-to-device, D2D, transmission resources. By the resource pool allocation the communication quality for all users can be optimized. For this optimization, it is necessary to provide a degree of occupation of at least one resource pool of resources used in device-to-device, D2D, communication between user equipment, UE, devices 1-i of the cellular network.

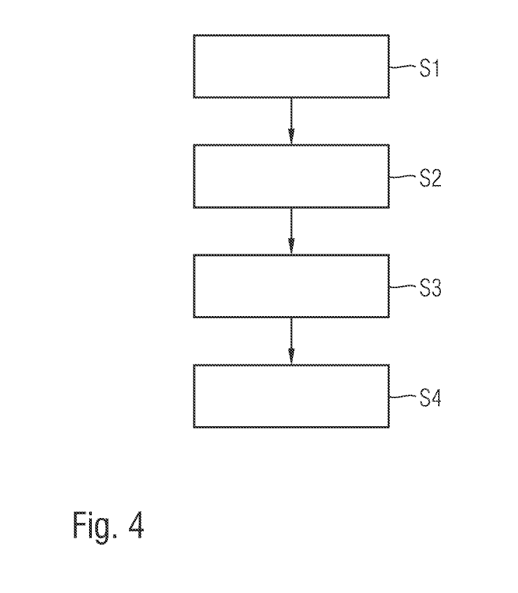

FIG. 4 shows a possible exemplary embodiment of a method for providing a degree of occupation of at least one resource pool of resources used in device-to-device, D2D, communication between user equipment, UE, devices 1-i of a cellular network according to an aspect of the present invention.

In a first step S1, at least one resource parameter of a resource is measured by a user equipment device 1-i.

In a second step S2, the user equipment device 1-i decides whether the respective resource of said resource pool is occupied depending on the measured resource parameter and at least one configurable decision criterion.

In a third step S3, the base station 2 of the cellular network cell 3 of the network is informed about the occupation of resources of the resource pool by the user equipment, UE, device 1-i when the user equipment device 1-i is in coverage of the base station 2.

Finally, the information about occupation of resources of said at least one resource pool received from said user equipment devices 1-i is evaluated in step S4 to derive the degree of resource pool occupation.

Either all or a subset of resources of one or more resource pools can be monitored by each user equipment, UE, device 1-i. The measured occupancy can be either sent to the base station 2 on a resource level, on a resource group level, on a resource block level or as a degree of occupancy of a resource pool using predefined or configurable parameters like time instant and duration of measurement and/or area to be considered for measurement. That a resource is considered occupied according to a predefined threshold can have two different reasons. The first reason is that the resource is used by a device-to-device, D2D, signal. The second possible reason is that the resource is unusable for device-to-device, D2D, transmission due to noise of interference from cellular traffic. With the method according to the present invention, the occupation level due to device-to-device, D2D, signaling and a possible change of resource pool allocation is determined.

A degree of occupancy, DoO, can be either determined directly by a user equipment, UE, device 1-i or at a base station 2 or in a control unit of the communication network. The degree of occupancy can be directly determined by the user equipment, UE, device 1-i with only a key parameter (like the degree of occupation) being sent by the user equipment, UE, device 1-i to the base station 2. In an alternative embodiment, the degree of occupancy is determined at the base station 2 of the network cell 3.

In a still further embodiment, the degree of occupancy, DoO, is determined by a remote control unit of the communication network. In this embodiment, either all measurement results are reported on a one-to-one basis or alternatively, all values above a threshold are sent from the user equipment, UE, device to the respective base station 2 increasing signalization efforts. The information about the occupation degree of resources used for device-to-device, D2D, communication can be used for dynamically adapting the assignment or allocation of resources. With the method according to the present invention, the network or control unit of the network is informed of the current degree of occupation of device-to-device resource pools in different areas of the network or network cell 3. In a possible embodiment, individual user equipment, UE, devices can be configured to measure the occupied resources. In a possible embodiment, a resource allocation of resources within network cell 3 of the base station 2 is changed in response to the derived degree of resource pool occupation. In a possible embodiment, at least one decision criterion is predefined to indicate when a resource is occupied. The decision criterion can comprise in a possible embodiment a configurable parameter threshold and the measured resource parameter is compared with the configurable parameter threshold by the user equipment device 1-i to decide whether the respective resource of said resource pool is occupied due to device-to-device, D2D, signaling. In a possible embodiment, the measured resource parameter comprises a signal strength and/or a signal power of signals received by the user equipment, UE, device from other user equipment, UE, devices via resources of said resource pool. In a further possible embodiment, the measured resource parameter can also comprise messages received by the user equipment, UE, device from other user equipment, UE, devices via resources of said resource pool. In a possible embodiment, the decision criterion comprises a decision whether a resource of said resource pool is used in device-to-device, D2D, signaling.

In a possible embodiment of the method according to the first aspect of the present invention, the user equipment, UE, device 1-i transmits to the base station 2 of the same network cell or to another base station a report message, RM, indicating a measured occupancy of resources of the respective resource pool. The measured occupancy can be transmitted by the user equipment, UE, device 1-i to the base station 2 on a resource level, a resource group level, a resource block level or as a degree of occupancy of a resource pool.

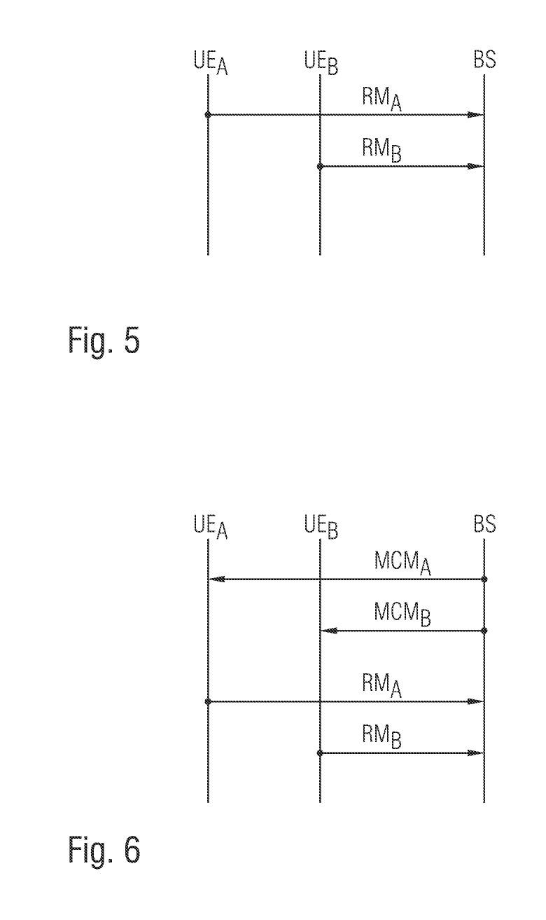

FIG. 5 illustrates the transmission of report messages, RM, by different user equipment devices UEA, UEB to a base station 2 of the communication network. Both resource messages RM_{A}, RM_{B} indicate a measurement occupancy of resources measured by the respective user equipment devices UEA, UEB. In a possible embodiment, the report message RM transmitted by a user equipment device is triggered by an occupation state of a resource of said resource pool. In an alternative embodiment, the report message RM can be transmitted by the user equipment, UE, device in response to a request received from the base station 2. In a still further alternative embodiment, the report messages, RM, can be transmitted by the user equipment, UE, devices periodically at a predetermined transmissible rate.

The report message, RM, transmitted by the user equipment, UE, device 1.i to the base station 2 comprises in a possible embodiment position data indicating a position of the user equipment, UE, device when performing the measurement of the at least one resource parameter of a resource of the resource pool. In a possible embodiment, measuring at least one resource parameter of the resource pool by the user equipment, UE, device is initiated by said user equipment, UE, device in response to a measurement command message, MCM, transmitted by the base station 2 to the respective user equipment device 1-i.

FIG. 6 illustrates an exemplary embodiment where the user equipment devices UEA, UEB receive a corresponding measurement command message, MCM, from the base station 2 of the communication network. The measurement command message, MCM, transmitted by the base station 2 can specify the at least one resource parameter to be measured by the user equipment, UE, device 1-i. In a further possible embodiment, the measurement command message, MCM, transmitted by the base station 2 can specify further parameters such as a measurement time period to be used by the user equipment, UE, device 1-i and/or an area for measurement of the resource parameter of the at least one resource of said resource pool. In a possible embodiment, the measurement command message, MCM, transmitted by the base station 2 can specify a set or subset of resources of at least one resource pool to be monitored by the user equipment, UE, device 1-i.

The measurement command message, MCM, can be sent to a specific user equipment, UE, device 1-i using a user equipment, UE, identifier and/or broadcasted.

In a still further possible embodiment, the measurement command message, MCM, transmitted by the base station 2 can specify at least one condition when a report message, RM, is to be transmitted by the user equipment, UE, device 1-i back to the base station 2. Information about occupation of resources of the resource pool carried in the report messages, RM, as illustrated in FIGS. 5, 6, of different user equipment devices UEA, UEB to the base station 2 is evaluated by the base station 2 to derive a degree of resource pool occupation in at least one network cell 3 of the communication network. In an alternative embodiment, the received information about occupation of resources of the resource pool carried in report messages, RM, of different user equipment, UE, devices can be forwarded by the base station 2 to a central control unit of the communication network, wherein the control unit is adapted to derive a degree of resource pool occupation in at least one network cell 3 of the communication network.

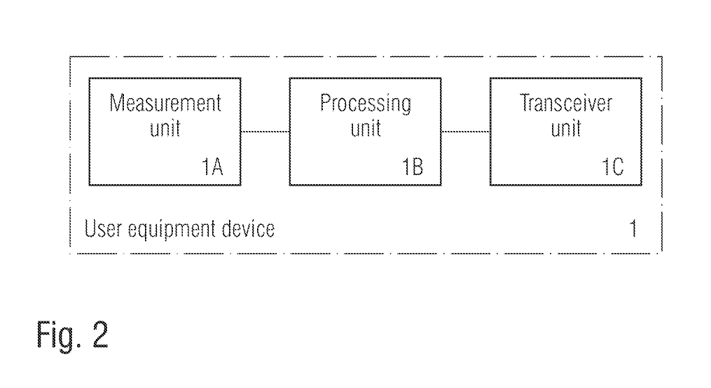

FIG. 2 shows a block diagram of a possible exemplary embodiment of a user equipment, UE, device 1 according to a further aspect of the present invention. The user equipment device 1 comprises in the illustrated embodiment a measurement unit 1A, a processing unit 1B and a transceiver unit 1C. The measurement unit 1A is adapted to measure at least one resource parameter of a resource of a resource pool used in device-to-device, D2D, communication between user equipment, UE, devices of the network. The processing unit 1B of the user equipment device 1 is adapted to decide whether a resource of said resource pool is occupied depending on the measured resource parameter received from the measurement unit 1A and depending on at least one configurable decision criterion. The transceiver unit 1C of the user equipment device 1 as illustrated in FIG. 2 is provided for communication of the user equipment, UE, device 1 with a base station 2 of said network and other user equipment devices. A report message, RM, is transmitted by the transceiver unit 1C of the user equipment device 1 to the base station 2 indicating a measured occupancy of resources of the resource pool.

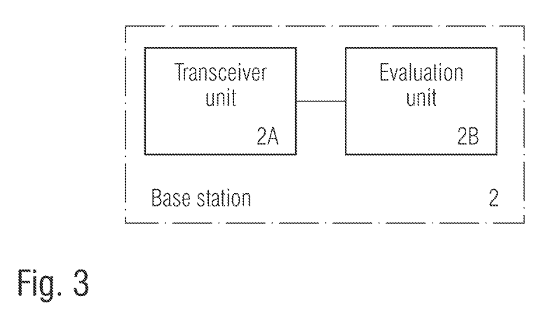

FIG. 3 shows a block diagram of a possible exemplary embodiment of a base station 2 according to a further aspect of the present invention. As illustrated in FIG. 3, the base station 2 comprises a transceiver unit 2A and an evaluation unit 2B connected to other entities of the communication network, in particular to a control unit of the network. The transceiver unit 2A of the base station 2 is adapted to transmit measurement command messages, MCM, to user equipment devices and to receive report messages, RM, from user equipment devices. The evaluation unit 2B is adapted to evaluate information about occupation of a set or subset of resources carried in the received report messages, RM, to derive a degree of resource pool occupation. In a possible embodiment, the base station 2 is further adapted to change a resource allocation of resources used within a network cell 3 of the base station 2 in response to the degree of resource pool occupation. In a possible embodiment, the base station 2 is formed by an eNodeB of a Long Term Evolution, LTE, communication network. The base station 2 can be adapted to communicate with mobile user equipment devices in coverage of the base station 2. The user equipment device 1 as illustrated in FIG. 1 is adapted for a device-to-device, D2D, communication and can measure upon request of the eNodeB at least one high frequency measurement value of a resource reserved for device-to-device, D2D, communication. In a possible embodiment, the measured resource parameter can be stored temporarily in a memory of the user equipment device 1. The base station 2 of the network is informed about the measured occupation of the resource via the transceiver unit 1C of the user equipment device 1 when the user equipment device 1 is in coverage of the base station 2. In a possible embodiment, the respective resource is decided to be occupied if the measured high frequency measurement value exceeds a predetermined threshold value and the resource is decided to be unoccupied when the high frequency measurement value is beneath a predefined threshold value. The high frequency measurement value can comprise a field strength of signals received from other terminal devices. Additional measurements can be performed at higher layers or protocol layers.

What is claimed is:

1. A method for providing a degree of occupation of at least one resource pool of resources used in device-to-device, D2D, communication between user equipment, UE, devices of a network, said method comprising the steps of:
(a) measuring at least one resource parameter of a resource by a user equipment, UE, device;
(b) deciding by said user equipment, UE, device whether the respective resource of said resource pool is occupied depending on the measured resource parameter and at least one configurable decision criterion;
(c) informing a base station, BS, of said network about the occupation of resources of said resource pool by the user equipment, UE, device when the user equipment, UE, device is in coverage of said base station, BS; and
(d) evaluating the information about occupation of resources of said at least one resource pool received from user equipment, UE, devices to derive the degree of resource pool occupation.

2. The method according to claim 1, wherein a resource allocation of resources within a network cell of said base station, BS, is changed in response to the derived degree of resource pool occupation.

3. The method according to claim 1 wherein the decision criterion comprises a configurable parameter threshold and the measured resource parameter is compared with the configurable parameter threshold by the user equipment, UE, device to decide whether the respective resource of said resource pool is occupied due to device-to-device, D2D, signaling.

4. The method according to claim 3 wherein the measured resource parameter comprises at least one of a signal strength, a signal power of signals, or messages received by said user equipment, UE, device from other user equipment, UE, devices via resources of said resource pool.

5. The method according to claim 1 wherein the decision criterion comprises a decision whether a resource of said resource pool is used in device-to-device, D2D, signaling.

6. The method according to claim 1 wherein the user equipment, UE, device transmits to the base station, BS, of said network a report message, RM, indicating a measured occupancy of resources of said resource pool.

7. The method according to claim 6 wherein the measured occupancy is transmitted by the user equipment, UE, device to the base station, BS, on a resource level, a resource group level, a resource block level or as a degree of occupancy of a resource pool.

8. The method according to claim 6 wherein said report message, RM, transmitted by said user equipment, UE, device is triggered by an occupation state of a resource of said resource pool or said report message, RM, transmitted by the user equipment, UE, device is transmitted in response to a request received from said base station, BS, or said report message, RM, transmitted by said user equipment, UE, device is transmitted periodically by said user equipment, UE, device.

9. The method according to claim 6 wherein the report message, RM, transmitted by said user equipment, UE, device to said base station, BS, comprises position data indicating a position of said user equipment, UE, device when performing the measurement of the at least one resource parameter of a resource of said resource pool.

10. The method according to claim 1 wherein measuring at least one resource parameter of said resource pool by said user equipment, UE, device is initiated by said user equipment, UE, device in response to a measurement command message, MCM, transmitted by said base station, BS, to said user equipment, UE, device.

11. The method according to claim 10 wherein the measurement command message, MCM, transmitted by said base station, BS, specifies the at least one resource parameter to be measured by said user equipment, UE, device and/or the measurement command message transmitted by said base station, BS, specifies a measurement time period to be used by said user equipment, UE, device and/or an area for measurement of the resource parameter of the resource of said resource pool.

12. The method according to claim 10 wherein the measurement command message, MCM, transmitted by said base station, BS, specifies a set or subset of resources of at least one resource pool to be monitored by said user equipment, UE, device.

13. The method according to claim 10 wherein the measurement command message, MCM, transmitted by said base station, BS, specifies at least one condition when a report message, RM, is to be transmitted by said user equipment, UE, device to said base station, BS.

14. The method according to claim 1 wherein the information about occupation of resources of said resource pool carried in report messages, RM, of different user equipment, UE, devices to said base station, BS, is evaluated by at least one of the base station, BS, or a control unit of said network, to derive a degree of resource pool occupation in at least one network cell of said network.

15. A user equipment, UE, device of a network, said user equipment, UE, device comprising:
a measurement unit adapted to measure at least one resource parameter of a resource of a resource pool used in a device-to-device, D2D, communication between user equipment, UE, devices of said network,
a processing unit adapted to decide whether a resource of said resource pool is occupied depending on the measured resource parameter and depending on at least one configurable decision criterion, and
a transceiver unit for communication of said user equipment, UE, device with a base station, BS, of said network and other user equipment, UE, devices,
wherein a report message, RM, is transmitted by said transceiver unit of said user equipment, UE, device to said base station, BS, indicating a measured occupancy of resources of said resource pool.

16. A base station, BS, of a network, comprising:
a base station transceiver unit for communication with user equipment, UE, devices being in coverage of said base station, BS, each user equipment, UE, device comprising:
a measurement unit adapted to measure at least one resource parameter of a resource of a resource pool used in a device-to-device, D2D,
communication between the user equipment, UE, devices of said network,
a processing unit adapted to decide whether a resource of said resource pool is occupied depending on the measured resource parameter and depending on at least one configurable decision criterion, and
a user equipment transceiver unit for communication of said user equipment, UE, device with the base station, BS, of said network and other user equipment, UE, devices,
wherein a report message, RM, is transmitted by said user equipment transceiver unit of said user equipment, UE, device to said base station, BS, indicating a measured occupancy of resources of said resource pool,
wherein said base station transceiver unit is adapted to transmit measurement command messages, MCM, to the user equipment, UE, devices and to receive the report messages, RM, from the user equipment, UE, devices.

17. The base station according to claim 16 comprising an evaluation unit adapted to evaluate information about occupation of a set or subset of resources carried in report messages, RM, received from user equipment, UE, devices to derive a degree of resource pool occupation.

18. The base station according to claim 17 wherein the base station, BS, is adapted to change a resource allocation of resources used within a network cell of said base station, BS, in response to the degree of resource pool occupation.

19. A network comprising:
at least one base station, BS, adapted to communicate with user equipment, UE, devices being in coverage of said base station, BS,
wherein each user equipment device comprises:
a measurement unit adapted to measure at least one resource parameter of a resource of a resource pool used in a device-to-device, D2D,
communication between the user equipment, UE, devices of said network,
a processing unit adapted to decide whether a resource of said resource pool is occupied depending on the measured resource parameter and depending on at least one configurable decision criterion, and
a user equipment transceiver unit for communication of said user equipment, UE, device with the base station, BS, of said network and other user equipment, UE, devices,
wherein a report message, RM, is transmitted by said user equipment transceiver unit of said user equipment, UE, device to said base station, BS, indicating a measured occupancy of resources of said resource pool, and
wherein the base station comprises a base station transceiver unit, wherein said base station transceiver unit is adapted to transmit measurement command messages, MCM, to the user equipment, UE, devices and to receive the report messages, RM, from the user equipment, UE, devices.

20. The network according to claim 19, wherein the network is a Long Term Evolution, LTE, network comprising at least one eNodeB as a base station, BS, adapted to communicate with mobile user equipment, UE, devices in coverage of said eNodeB.
